(19) United States
(12) Patent Application Publication
(10) Pub. No.: US 2012/0218789 A1
(43) Pub. Date: Aug. 30, 2012

(54) Electrical Power Conditioner

(76) Inventor: Phillip Gerard LANGHORST, St. Louis, MO (US)

(21) Appl. No.: 13/404,488

(22) Filed: Feb. 24, 2012

Related U.S. Application Data
(60) Provisional application No. 61/446,912, filed on Feb. 25, 2011.

(51) Int. Cl. H02M 5/451

(52) U.S. Cl. 363/37

(57) ABSTRACT

This invention presents an electrical power conditioner in the form of an electrical drive system for a machine, motor or generator. The electrical drive system has both variable frequency and fixed frequency modes. The electrical drive system includes power conditioners of less than full capacity for the variable frequency mode and a direct connection switch of full capacity for the fixed frequency mode. The electrical drive system is capable of supplying or receiving power from a variable speed electrical machine. The electrical drive system is particularly useful for wind turbines.

### CROSS-REFERENCE TO RELATED APPLICATIONS

This application claims priority to U.S. Provisional Patent Application no. 61446912 filed Feb. 25, 2011.

### STATEMENT REGARDING FEDERALLY SPONSORED RESEARCH OR DEVELOPMENT

Not Applicable.

### APPENDIX

Not Applicable.

### FIELD OF THE INVENTION

This invention generally relates to the electrical drive system of electric machines (motors and generators) and, more particularly, to a drive that has both variable and fixed frequency modes which is particularly useful in wind turbines.

### BACKGROUND OF THE INVENTION

It is well know that many fluid process and wind turbines are more efficient when operated a lower speeds. Wind turbines normally do not have adjustable transmissions. In order to reduce the speed of the turbine the generator must also reduce in speed. Reducing the speed of and AC generator requires a change in the frequency of supplied power.

Achieving variable speed operation to match wind condition has been accomplished generally either with a variable frequency power converter that is capable of the turbine's full rating or by using a doubly fed generator and a variable frequency power converter of partial rating applied to the rotor windings.

Both power converters and doubly fed generators are expensive relative to fixed speed electrical machines. Wind turbine systems must be made at low cost in order to be competitive with fossil fuel. The invention described provides a way to lower cost by reducing the power rating of the required electrical converters and to eliminate the expensive doubly fed generator.

### SUMMARY OF THE INVENTION

The present invention has been made to solve the above mentioned problems occurring in the prior art, and it is an object of the present invention to provide an electrical drive system at lower cost. It is another object of the present invention to provide variable speed operation at the lower speed conditions where variable speed operation provides the most benefit.

To achieve the above object, in one aspect of the present invention, there is provided a pair of variable frequency power converter capable of receiving power over a wide range of frequencies and delivering power into grid or buss which operates at a fixed frequency. The power converters need only be capable of part of the associated electrical machine's rating. The term “electrical machine” is used throughout to denote either an electrical motor or an electrical generator. In addition the present invention provides a means to connect the generator directly to the fixed frequency grid. The direct connection being capable of the full machine power rating. The combination of part rated power converters and fully rated direct connection being less expensive than the prior art.

In a preferred embodiment of the present invention, the power converters includes one machine side rectifying inverter for converting AC power into DC power and one grid side inverter for converting DC power into AC power. Additionally, each inverter is connected to filtering consisting of inductors and capacitors to control and smooth inverter current.

In a preferred embodiment, the direct machine-to-grid connection is made with a switch such as a mechanical contactor. In and alternative embodiment, the switch can be an electronic switch such as a silicon controlled rectifier (SCR) pack. In and alternative embodiment, both electronic and mechanical switches can be used to take advantage of the electronic switch's speed and cycling capability and mechanical switch's efficiency.

In a preferred embodiment, the machine side power converter would be controlled in order that its frequency matches the speed of the machine in such a way to optimize the power output of the wind turbine. This can be accomplished by allowing the machine to achieve a speed in proportion to the wind speed such that the tip speed ratio is kept optimum. When wind conditions require a machine frequency near or above the grid frequency, the machine side power converter would be controlled in order that its frequency and amplitude be exactly equal to and in phase with the grid potential.

In a preferred embodiment, the direct machine to grid connection would be used (closed) anytime the power available from the machine exceeds the capacity of the power converters. This would by design occur at a time when the machine side power converter has achieved synchronism with the grid. The direct connection switch can be close at this time.

At the time the direct connection is made, the machine side power converter would be controlled in order that its electrical current is reduced, effectively transferring power to the direct path.

In a preferred embodiment, when the direct connection is made the machine side power converter would change mode and be controlled such that it only processes reactive power (VARs) and provides power factor correction for the system. In an alternative embodiment when the direct connection is made the machine side power converter would de-energize.

In a preferred embodiment, the grid side power converter is controlled in separate non conflicting modes; a) adjustment of its phase relative to the grid in order to maintain its DC input voltage. This mode will transfer real power b) adjustment of its amplitude relative to the grid in order to control reactive power (VARs). This mode allows control of system power factor.

In a preferred embodiment, both power converters would have generally one half the capacity of the machine.

In yet another aspect of the present invention, there is a second filtering stage to smooth output current. This filter would be comprised of transformers or inductors and capacitors.

In a preferred embodiment of the present invention, the series element of the second stage filter would be a transformer, the same transformer used to increase potential (voltage) for more efficient transmission.

In a preferred embodiment, the capacitors of the second stage filter would be connected to the higher potential of the transmission transformer.

In an alternative embodiment, inductors and capacitors of second filtering stage would be connected to the grid side of direct connection switch.

In any embodiment, there are two paths power can flow. Using the direct path the machine operates at fixed frequency, essentially fixed speed and power is unregulated. Using the converters path the machine can operate over a range of frequencies (speeds) and power can be regulated by control of inverter parameters.

### BRIEF DESCRIPTION OF THE DRAWINGS

FIG. 1 is a schematic diagram of preferred embodiment of the invention.

FIG. 2 is a schematic diagram an alternate embodiment of the invention.

FIG. 3 is a table showing component operation in four control modes.

### DETAILED DESCRIPTION OF THE INVENTION

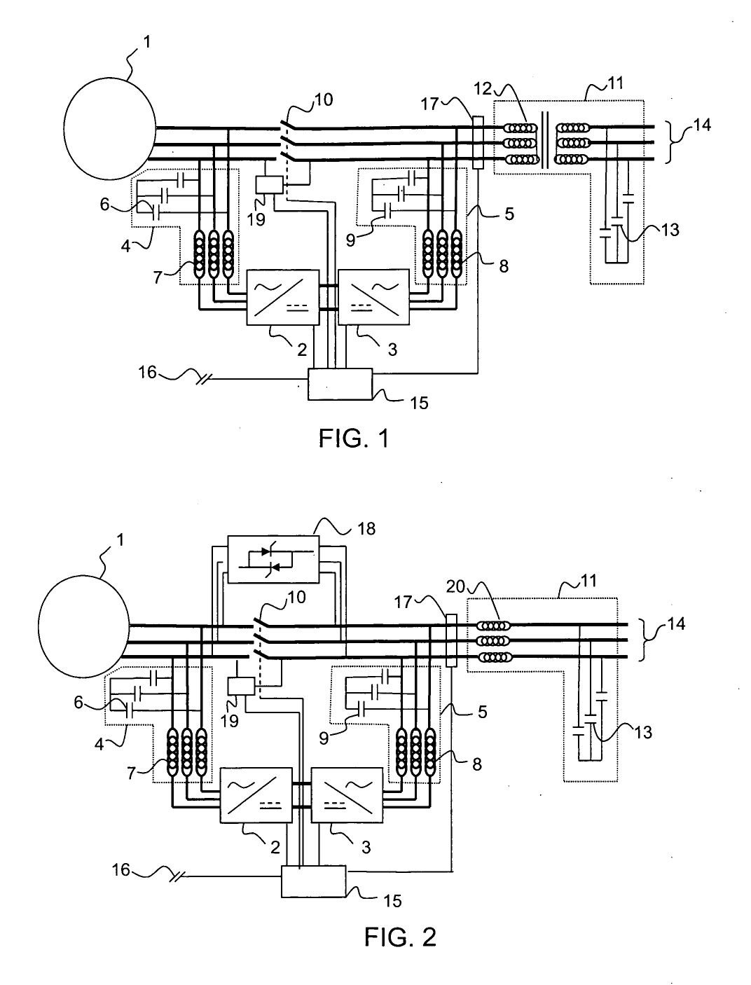

In FIG. 1 there is shown an electrical drive system. The electrical machine 1 can be a motor or a generator. The electrical machine connects (at a point generally referred to as first node) to the machine side filter 4 and the direct connection switch 10. Fixed frequency grid 14 connects to direct connection switch 10 through second stage filter 11. Grid side inverter 3 and machine side inverter 2 share a common DC buss.

From machine 1 to electrical network grid 14 there are two paths power can take: a direct path via a first circuit comprising direct via second stage filter 11 and direct connection switch 10, or an indirect path via the first circuit disposed in parallel with a second circuit, the second circuit comprising machine side filter 4, machine side inverter 2, grid side inverter 3, grid side filter 5 and second stage filter 11.

A grid sensor 17 converts the grid voltage and current measurements into a form suitable for controller interface.

A differential sensor 19 converts the voltage across the direct connection switch 19 into a form suitable for controller interface.

A central controller 15 is connected to sensors 17 and 19, external controllers or sensors 16, communicates with inverters 2, 3 and can force the closure of direct connecting switch 10. The central controller is capable of adjusting machine side frequency to optimize system performance as sensed via connection 16 and is responsible for insuring synchronism between the electrical network grid 14 and the machine terminal voltage prior to forcing closure of the direct connecting switch 10. The central controller can also communicate with inverters 2, 3 and set the level of reactive power (VARs) in order to achieve a desired power factor at the connection (generally and alternately referred to as second node) to electrical network grid 14.

The machine side filter 4 includes inductors 7 and capacitors 6. Inductors 7 reduce current ripple and capacitors 6 reduce voltage ripple insuring machine 1 is not exposed to excessive ripple.

The grid side filter 5 includes inductors 8 and capacitors 9. Inductors 8 reduce current ripple and capacitors 9 reduce voltage ripple insuring excessive ripple is not injected into the electrical network grid 14.

The second stage filter 11 includes transformer 12 and capacitors 13. The leakage impedance of transformer 11 reduces current ripple and capacitors 9 reduce voltage ripple further insuring excessive ripple is not injected into the electrical network grid 14.

In an alternate embodiment, inductors 20 take the place of transformer 12. The inductor's impedance reduces current ripple injected into the electrical network grid 14.

In an alternate embodiment, electronic switch 18 takes the place of or can be used in concert with mechanical switch 10.

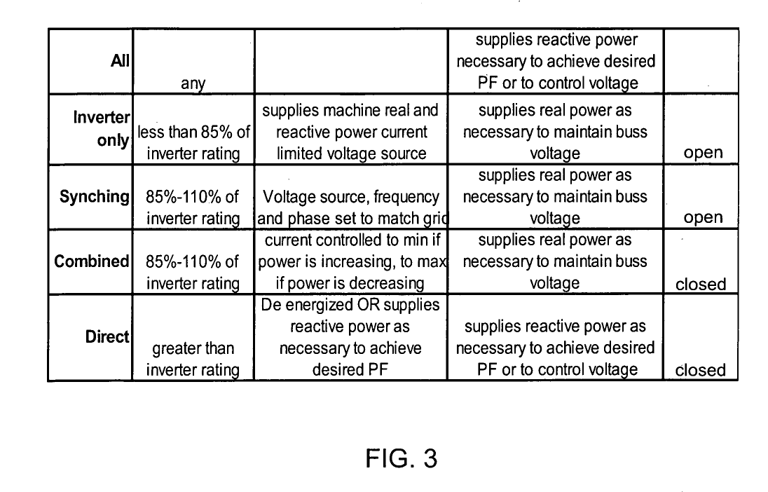

The operation of the invention and be divided into four different modes. The control of machine side inverter, grid side inverter, and direct connection switch are described in FIG. 3.

The control functions may be executed by the central controller 15, by the inverters themselves, or by a combination of both.

In all modes of operation the grid side inverter 3 supplies reactive power to the grid 14 and is controlled such that the desired power factor is achieved. The power factor may be measure internally to the inverter, internal to the system, or at the point of common coupling with the grid. In an alternate embodiment the reactive power may be controlled independent of the local power factor. The reactive power may be controlled by an external controller 16 that desires to regulate the power factor or to stabilize the voltage in some remote part of the grid.

In all modes of operation, the grid side inverter 3 supplies or accepts real power to or from the electrical network grid 14 (depending on whether power is being transferred from electrical machine 1 to electrical network grid 14, or on whether power is being transferred from electrical network grid 14 to electrical machine 1) and is controlled such that the desired DC buss voltage is achieved. In the directly connected operation mode there will be no real power to process.

During inverter only operation the direct connecting switch 10 is open and all power flow is through both inverters 2, 3. The machine side inverter 2 supplies both real and reactive power to or from the electrical machine 1. It can be controlled as voltage source or current regulated voltage source.

During synching operation the direct connecting switch 10 is open and all power flow is through both inverters 2, 3. The machine side inverter 2 supplies both real and reactive power to or from the electrical machine 1. It is controlled as voltage source and its voltage, frequency, and phase are forced to match the grid potential as measured by grid sensor 17 or alternately by differential sensor 19.

During combined operation the direct connecting switch 10 is closed. Power can flow through inverters 2, 3 and through the direct connecting switch 10. The machine side inverter 2 is connected to both the grid and electric machine in this mode. The machine side inverter 2 is controlled such that its current it driven to a) a minimum value if system power is anticipated to increase or b) a maximum value if system power is anticipated to decrease. The information required to anticipate the amount of system power comes for external reference 16. The information could be in the form of speed, fuel or resource availability, wind speed. In another embodiment, the central controller 15 may be adapted to save and use historical information in order to anticipate the system power in the immediate future.

An important feature of the invention is that at the instant the direct connecting switch 10 closes, there is very little voltage across it due the method of control in the synching mode of operation. Also there is very little current in the direct connecting switch 10 at the instant it opens due to the method of control in them combined mode of operation. The combination of low voltage closure and low current opening will allow prolonged life of the direct connecting switch 10.

During direct connected operation the direct connecting switch 10 is closed and all real power flows through it. The machine side inverter 2 is connected to both the grid and electric machine in this mode. The machine side inverter 2 can be either a) disabled, or b) controlled to supply reactive power to the grid 14, augmenting the reactive power being supplied by the grid side inverter 3.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. For example, it should be appreciated that while the invention may be operated by delivering power from electrical machine 1, through the first and/or second circuits, to electrical network grid 14, the invention may also be operated in the reverse—by delivering power from electrical network grid 14, through the first and/or second circuits, to electrical machine 1. Thus, the breadth and scope of the present invention should not be limited by any of the above-described exemplary embodiments, but should be defined only in accordance with the following claims appended hereto and their equivalents.

What is claimed is:

1. An electrical power conditioner, comprising:
a first node adapted for connection to an electrical machine;
a second node adapted for connection to an electrical network;
a first circuit disposed between said first node and said second node, and having a switch;
a second circuit disposed between said first node and said second node, and in parallel with said first circuit, said second circuit having a machine side inverter in electrical communication with said first node, a grid side inverter in electrical communication with said second node, said machine side inverter in electrical communication with said a grid side inverter
a controller for adjusting power flow through said second circuit by adjustment of operating parameters of said machine side inverter and for adjusting power flow through said first circuit by means of directing the position of said switch
a sensor connected to said controller providing phase information which allows controller to effect synchronism between said first node and send second node.

2. An electrical power conditioner according to claim 1, further comprising an electrical machine side filter disposed between said first node and said machine side inverter.

3. An electrical power conditioner according to claim 1, further comprising an electrical grid side filter disposed between said second node and said grid side inverter.

4. An electrical power conditioner according to claim 3, wherein said electrical grid side filter is comprised of series inductors and parallel connected capacitors.

5. An electrical power conditioner according to claim 3, wherein said electrical grid side filter is comprised of a series transformer and parallel connected capacitors.

6. An electrical power conditioner according to claim 1, wherein said electrical machine is an induction generator.
